(19) United States
(12) Patent Application Publication
(10) Pub. No.: US 2015/0134452 A1
(43) Pub. Date: May 14, 2015

(54) MECHANISM FOR FACILITATING DYNAMIC AND TARGETED ADVERTISEMENTS FOR COMPUTING SYSTEMS

(71) Applicant: Gerald Shawn Williams, Macungie, PA (US)

(72) Inventor: Gerald Shawn Williams, Macungie, PA (US)

(21) Appl. No.: 13/977,474

(22) PCT Filed: Mar. 15, 2013
(86) PCT No.: PCT/US13/32625

§ 371 Date: Jun. 28, 2013

(51) Int. Cl. G06Q 30/02

(52) U.S. Cl. CPC G06Q 30/0257
USPC 705/14.55

(57) ABSTRACT

A mechanism is described for facilitating dynamic and targeted advertisements for computing systems according to one embodiment. A method of embodiments, as described herein, includes transmitting an indication that one or more advertisements are being played at the computing device, determining whether a user profile associated with a user of the apparatus has a sufficient amount of advertisement credits to allow the user to receive an advertisement-free experience relating to an advertisement-sponsored application, and providing the advertisement-free experience if the user profile includes the sufficient amount of advertisement credits.

### FIELD

Embodiments described herein generally relate to computer programming More particularly, embodiments relate to a mechanism for facilitating dynamic and targeted advertisements for computing systems.

### BACKGROUND

Advertisement-driven revenue has become increasingly common and necessary, particularly as software and services move to applications and web services that often require continuous support and maintenance. However, these revenue-generating advertisements are not only annoying to users, but also leave most users insecure about their privacy when user data is often accessed for such purposes. Most common forms of conventional advertisement techniques include a frequent appearance of banners, popups, etc., during a user's use of a software program.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a dynamic and targeted advertising mechanism employed at a computing device according to one embodiment.

FIG. 2 illustrates a dynamic and targeted advertising mechanism according to one embodiment.

FIG. 3 illustrates a method for facilitating dynamic and targeted advertisements for computing systems according to one embodiment.

FIG. 4 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a dynamic, efficient, and targeted distribution of advertisements for computing systems. Embodiments facilitate a combination of an intelligent use of user preferences and user credit system to promote user control of advertisements while offering incentives through the credit system both for the user as well as for other involved parties, such as businesses, advertisement sponsors, and other vendors, etc.

A mechanism is described for facilitating dynamic and targeted advertisements for computing systems according to one embodiment. A method of embodiments, as described herein, includes transmitting an indication that one or more advertisements are being played at the computing device, determining whether a user profile associated with a user of the apparatus has a sufficient amount of advertisement credits to allow the user to receive an advertisement-free experience relating to an advertisement-sponsored application, and providing the advertisement-free experience if the user profile includes the sufficient amount of advertisement credits.

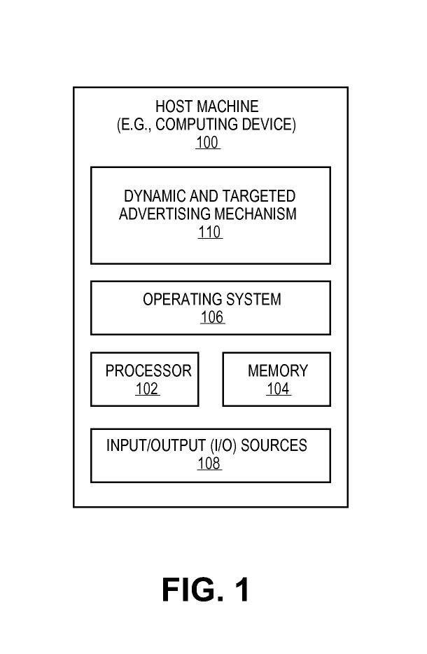

FIG. 1 illustrates a dynamic and targeted advertising mechanism 110 employed at a computing device 100 according to one embodiment. Computing device 100 serves as a host machine for employing dynamic and targeted advertisement mechanism (“advertisement mechanism”) 110 to facilitate dynamic, efficient, targeted, and economically-profitable placement and distribution of advertisements to user computing devices.

Computing device 100 may include mobile computing devices, such as cellular phones including smartphones (e.g., iPhone® by Apple®, BlackBerry® by Research in Motion®, etc.), personal digital assistants (PDAs), etc., tablet computers (e.g., iPad® by Apple®, Galaxy 3® by Samsung®, etc.), laptop computers (e.g., notebook, netbook, Ultrabook™, etc.), e-readers (e.g., Kindle® by Amazon®, Nook® by Barnes and Nobles®, etc.), etc. Computing device 100 may further include set-top boxes (e.g., Internet-based cable television set-top boxes, etc.), and larger computing devices, such as desktop computers, server computers, etc.

Computing device 100 includes an operating system (OS) 106 serving as an interface between any hardware or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “computing device”, “node”, “computing node”, “client”, “host”, “server”, “memory server”, “machine”, “device”, “computing device”, “computer”, “computing system”, and the like, may be used interchangeably throughout this document.

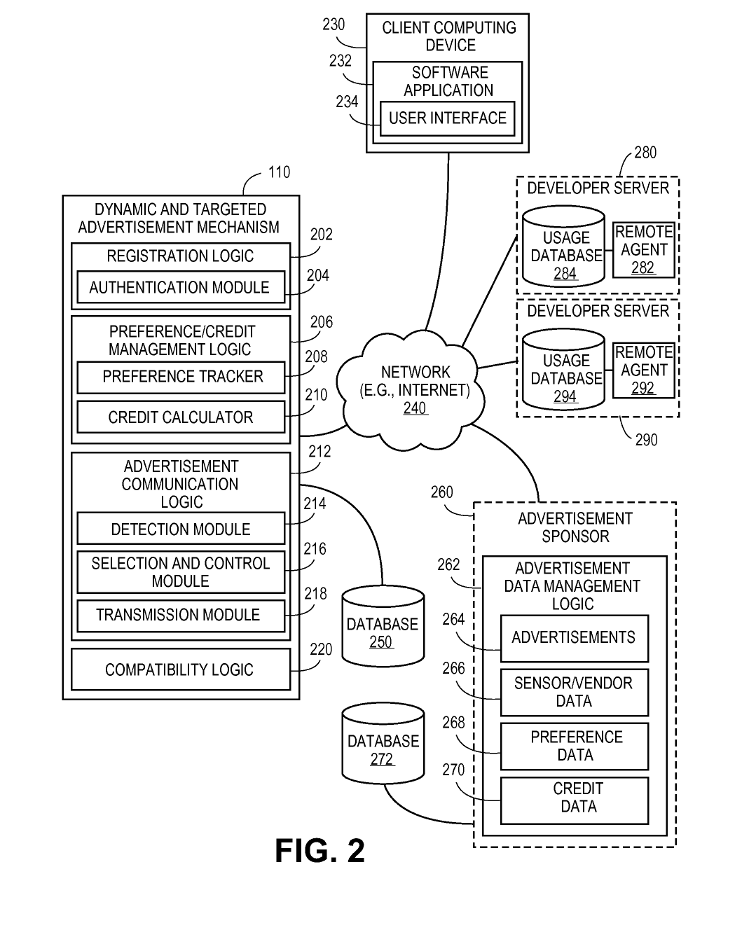

FIG. 2 illustrates a dynamic and targeted advertising mechanism 110 according to one embodiment. In one embodiment, advertisement mechanism 110 includes a number of components, such as registration logic 202 including authentication module 204, preference/credit management logic 206 including preference tracker 208 and credit calculator 210, advertisement communication logic 212 having detection module 214, selection and control module 216, transmission module 218, and compatibility logic 220. Advertisement mechanism 110 may be in communication with a database 250 and any number and type of computing systems serving as client computing devices, such as client computing device 230 having a software application 232 providing a user interface 234, over a network, such as network 240, such as the Internet, a cloud-based network, etc. Further, in one embodiment, over network 240, advertisement mechanism 110 may be further in communication with one or more optional server computing systems associated with third-party organizations serving as advertisement sponsors/suppliers for management of advertisement-related data, such as advertisements 264, sponsor/vendor data 266, preference data 268, and credit data 270. Advertisement server 260 may be in communication with a database 272, local and/or remote, to store data relating to or managed by advertisement data management logic 262. In another embodiment, advertisement sponsor 260 may be optional as its tasks may be performed by advertisement mechanism 110. Throughout this document, “logic” may be interchangeably referred to as “component” or “module” and may include, by way of example, software, hardware, and/or any combination of software and hardware, such as firmware.

In one embodiment, targeted advertisement software applications corresponding with various organizations are offered to users so a user may choose to play any number and type of advertisements associated with an advertisement application and receive credit for doing so. For example, an advertisement software application may be associated with nytimes.com, where users visiting nytimes.com may have the option of playing one or more advertisements offered by the advertisement application associated with the nytimes.com. In one embodiment, the advertisement application may be provided as a separate downloadable software application that a user may choose to download on client computing device 230 or be a cloud-based application accessible via a cloud network, such as network 240, or be provided as a separate website or integrated with a vendor website (such as nytimes.com), or the like. The illustrated software application 232 represents all of the aforementioned forms of providing an advertisement application to a user at client computing device 230. Further, user interface 234 for user to perform various tasks, such as register for or choose to participate in the targeted advertisement program, select an advertisement (such as one or more advertisements relating to the sale at Macy's®, New York Yankees® tickets for the new season, Home Depot® coupons, etc.), play the advertisement, keep track of the advertisement account, such credits earned or spent, etc. It is to be noted that embodiments are not related to any number or type of businesses, organizations, websites, advertisements, etc., and that certain examples are used throughout this document for brevity, clarity, and ease of understanding.

In one embodiment, advertisements credits may be used by the user to have an advertisement-free experience of, for example, using a software application. The user may gain credits by watching advertisements for a period or number of times or by purchasing consumer products and/or services and can then spend those credits to have an advertisement-free experience. In one embodiment, the advertisement credits may be tracked in a user profile. A sufficient amount of can be non-zero number of credits. The user may be able to use even the smallest amount of credit, such as non-zero credit, to have a short period of time (e.g., a minute or two) of advertisement-free application experience. The user may replay the same or play other advertisements and/or shop for products and/or services to earn more advertisement credits to have advertisement-free experience and/or use some or all of the credits for more shopping for products and/or services.

Continuing with the example, the user may choose to opt-in or register for targeted advertisement applications, via user interface 234, with is received at registration logic 202. For example, the user may of provided a welcome page to enter some basic information (e.g., first and last names, age, location, userlD, password, email address, telephone number, etc.) to register. Upon registering, authentication module 204 may authenticate the user, such as by sending an email to the user requesting a reply to the email. Once registered, the user may access the advertisement application by simply entering one or more of a userID, an email address, a password, a passcode, etc. In some embodiments, authentication module 204 may be used to authenticate not only the user, but also client computing device 230 and this may be a one-time process or a recurring process.

In one embodiment, preference/credit management logic 206 maintains any information relating to user preferences and credits. For example, preference tracker 208 may track user preferences using the information provided by the user, such as the user may have provided information about the preference for sports advertisements, fine restaurant deals, hardware stores, video games, electronics, and, during holidays, department store advertisements, etc. This way the user may be preferred advertisements that reconcile with the user preferences, eliminating the user annoyance with the conventional random popup advertisements. For example, using the user preferences, when accessing an exclusive advertisement website/application (e.g., a sponsor application exclusively dedicated to advertisements of one or more sponsors) or any other software applications, such as business applications, video games, etc., or other website, such as nytimes.com, espn.com, government or education websites, etc., the user may be offered a Dish® network advertisement offering cheaper sports packages or a Home Depot® advertisement for 20%-off deals for the current week, video game advertisements, etc. Preference data obtained by preference tracker 208 may be stored at database 250 for future access, analysis, and use. In some embodiments, user preferences may be maintained by advertisement sponsor 260 as preference data 268, where preference data 268 may be obtained by preference tracker 208 to be used with the preference data at database 250 for better offering of advertisements to the user.

Preference data may be applied to earned credit (e.g., applying immediately to the following applications, crediting an account, etc.) by producing some of the credit management activities relating to the user. In some embodiments, some or all of the components and their relevant functionalities may be employed or duplicated at client computing device 230. This may be done for convenience or to speed up local transactions or fur auditing purposes, etc. For example, remote auditing may be performed by third parties getting paid for providing services and/or applications may be purchased using earned credits (e.g., including for the application used to earn credits, etc.). For example, as illustrated, optional developer server computers 280, 290 may be employed (or over cloud-based network, such as network 240) having remote agents 282, 292 and usage databases 284, 294 for various purposes, such as software application development and supply, advertisement development and supply, flow and application of user credits, flow and application of money relating to user credits, etc., over network 240. For example, the user may choose to use the available credit to purpose software application, etc., and to accomplish that, advertisement sponsor 260 may provide credit (e.g., as money, etc.) to one or more developer servers 280, 290 to perform the task.

In some embodiments, components 202-220 of advertisement mechanism 110 may employed entirely at a single server computing system, such as host machine 100 of FIG. 1, or any number and type of components 202-220 may be employed at any number and type of computing systems, such as one or more of the option server computers 260, 280, 290 illustrated here or even at one or more of a client computing systems, such as client computing device 230.

In one embodiment, a user's account may be incremented with an amount of credit each time the user play an advertisement, such as the user may earn credits by playing advertisements and those earned credits may then be redeemed by the user credits to, for example, buy products, services, discounts, payoff back payments, etc. For example, a simply predetermined credit strategy may be employed, such as each time an advertisement is played, the user may earn a corresponding value in the form of credit money (e.g., $0.25/advertisement, $1.00/3 advertisements, etc.). As aforementioned, these credit may then be used by the user to, for example, pay newspaper subscription, redeem as a coupon at a department store, pump gasoline, pay for an oil change, etc. The technique is to encourage the user to choose to play advertisements, eliminating the conventional technique of unwanted, untimely, and annoying popup and/or banner advertisements. In one embodiment, these credits may be calculated using credit calculator 210 and maintained at database 250 for future calculations, analysis and use as well as for the user to check, withdraw, and/or redeem. As with preference data, credit data 270 may be determined (e.g., changes to the credit amounts, such as increase or decrease credit amounts associated with certain advertisements, etc.) and maintained by advertisement sponsor 260. Further, in some embodiments, credit data 270 may be obtained and/or used by credit calculator 210 along with credit data at database 250 to achieve a more accurate and precise credit balance for better and more intelligent offerings of advertisements to the user.

In one embodiment, advertisement communication logic 212 facilitates communication of data, including advertisements, between a server computer (such as host machine 100 of FIG. 1 hosting advertisement mechanism 110) and client computing device 230 and advertisement sponsor 260 over network 240 and with database 250. Detection module 214 detects a user's attempt to play an advertisement, such as when the user click on an icon to play an advertisement or connects to a specialized sponsor advertisement application or accesses via any website. The detection is forwarded on to selection and control module 216 which selects the appropriate advertisement for the user.

The selection process may include selecting the advertisement chosen by the user, selecting a more relevant or appropriate advertisement based on the review of the user profile. For example, a particular advertisement may be automatically chosen for the user (if that flexibility is provided by the user in the user preferences) based on greater savings better location, etc., or because it relates to a particular vendor preferred by the user or with whom the user has a significant amount of credit. Similarly, for example, an advertisement that might be inappropriate for the user (e.g., due to age, etc.) might not be displayed and instead another advertisement may be selected. Additionally, as with preference and credit data 268, 270, in one embodiment, advertisements 264 and sponsor/vendor data 266 may be used to assist selection and control module 216 to select the best advertisement for the user. For example, advertisements 264 and sponsor/vendor data 266 may be accessed for recommendations relating to advertisements and sponsors/vendors, respectively. Once the selection is made, the selected advertisement may be transmitted on to client computing device 230 for the user to play.

In one embodiment, selection and control module 216 may evaluate a user profile, stored at database 250, to determine the advertisement, where user profile may include, but not limited to, user personal data, user preferences, and/or advertisement credits. For example, user personal data may include data provided by the user at the time of or anytime subsequent to registration. The user personal data may include information relating to the user, such as, but not limited to, user name, user age, user gender, user location, user income, and user login. The user preference data may be tracked or obtained by preference tracker 208 and include information regarding preferences relating to the user, such as, but not limited to, preferred websites, preferred vendors, preferred shopping items, and shopping habits.

In one embodiment, credits (e.g., monetary credits) may be offer to the user and added to the user profile for each advertisement that is received and/or played by the user. For example, upon playing an advertisement, a corresponding amount of monetary credit (e.g., $0.50 for playing the advertisement once) may be credited or added to a user credit account at the user profile. As aforementioned, the monetary credits (although embodiments are not limited to monetary credits and it is contemplated that other types of credits (e.g., free service, debt forgiveness, etc.) may also be applied) may be redeemed by the user for purchasing or paying off for products or services, etc.

Configuration logic 220 may facilitate the ability to dynamically stay configured with various computing devices (e.g., mobile computing devices (such as various types of smartphones, tablet computers), networks (e.g., Internet, cloud-computing network, etc.), websites, (such as social networking websites (e.g., Facebook®, LinkedIn®, Google+®, etc.)), etc., while ensuring compatibility with changing technologies, parameters, protocols, standards, etc.

It is contemplated that any number and type of components may be added to and/or removed from advertisement mechanism 110 to facilitate various embodiments including adding, removing, and/or enhancing certain features. For brevity, clarity, and ease of understanding of the advertisement mechanism 110 many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

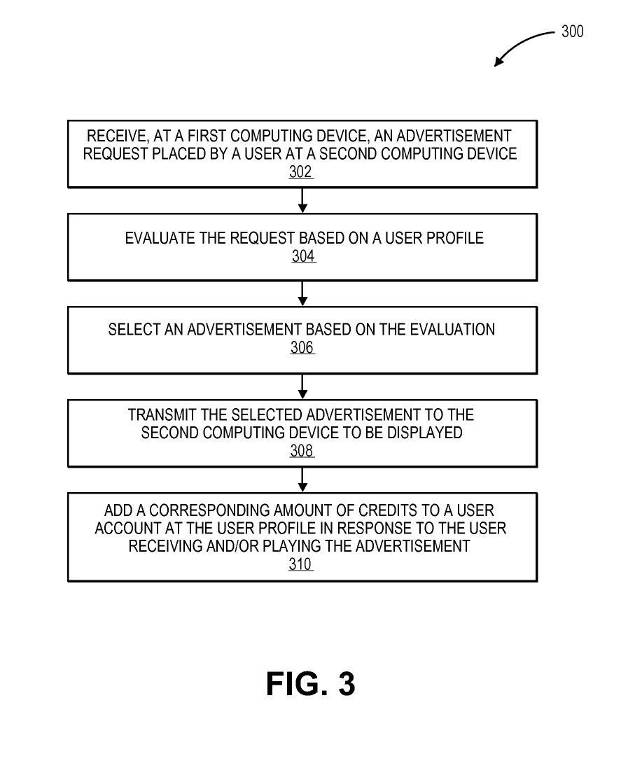

FIG. 3 illustrates a method 300 for facilitating dynamic and targeted advertisements for computing systems according to one embodiment. Method 300 may be performed by processing logic that may comprise hardware (e.g., circuitry, dedicated logic, programmable logic, etc.), software (such as instructions run on a processing device), or a combination thereof. In one embodiment, method 300 may be performed by advertisement mechanism 110 of FIG. 1.

Method 300 begins at block 302 with receiving, at a first computing device, an advertisement request placed by a user at a second computing device. At block 304, the request is evaluated based on a user profile including user preferences and user credits. At block 306, an advertisement is selected based on the evaluation. At block 308, the selected advertisement is transmitted on to the second computing device where it may be played by the user. At block 310, upon playing (e.g., viewing, listening, etc.) of the advertisement, a corresponding amount of credit is added to the user's credit account for future use/redemption.

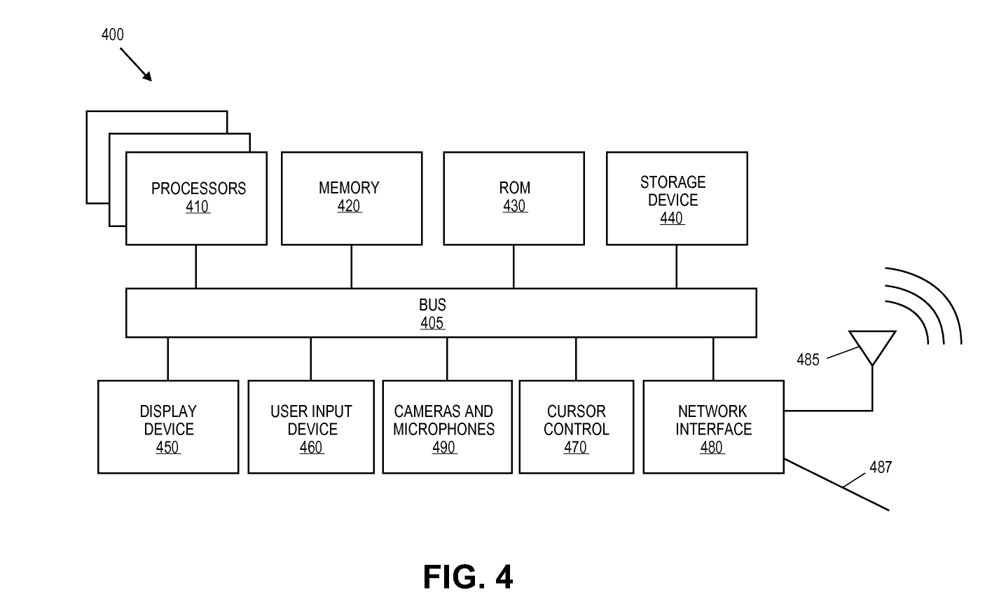

FIG. 4 illustrates an embodiment of a computing system 400. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components. Computing device 400 may be the same as or similar to or include computing device 100 of FIG. 1 to employ advertisement mechanism 110, or computing device 230 of FIG. 2.

Computing system 400 includes bus 405 (or a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Some embodiments pertain to a method comprising: detecting an advertisement request comprising user information received from a computing device; evaluating the request based on a user profile associated with a user associated with the user information, wherein evaluating includes selecting an advertisement based on the evaluation of the request; calculating and assigning an amount of advertisement credit to the user profile; and transmitting the selected advertisement to be displayed at the computing device.

Embodiments or examples include any of the above methods wherein the user profile includes one or more of user personal data, user preferences, and advertisement credits, wherein the user profile is stored at a database.

Embodiments or examples include any of the above methods wherein the user personal data comprises one or more of user name, user age, user gender, user location, user income, and user login, wherein the user personal data uniquely identifies the user or the computing device without identifying other user personally-identifiable user information.

Embodiments or examples include any of the above methods further comprising tracking and maintaining the user preferences relating to the user, wherein the user preferences include one or more of preferred websites, preferred vendors, preferred shopping items, and shopping habits, wherein the user preferences include advertising preferences.

Embodiments or examples include any of the above methods wherein the amount of advertisement is calculated to be corresponding to the selected advertisement and deposited to the user profile to be added to the advertisement credits, wherein the advertisement credits include redeemable monetary credits or non-monetary credits, wherein the advertisement credits are redeemable for one or more of purchasing, renting, leasing, and selling of one or more of services, consumer products or goods, software applications, outstanding balances, and other tangible and non-tangible items.

Embodiments or examples include any of the above methods further comprising registering the user, wherein registering includes creating the user profile and authenticating one or more of the user and the computing device.

Embodiments or examples include any of the above methods wherein evaluating further comprises performing selection of the advertisement based on evaluation of user/advertisement data obtained from a third-party organization managing the user/advertisement data including one or more of advertisements, sponsor/vendor data, preference data, and credit data.

Embodiments or examples include any of the above methods wherein the request is placed by the user via a user interface provided by a software application at the computing device, wherein the computing device comprises a client computing device including one or more of a desktop computer, a set-top box, a mobile computer including one or more of a smartphone, a personal digital assistant (PDA), a tablet computer, an e-reader, and a laptop computer, wherein the computing device is coupled to a server computing device over a network, the network including one or more of a cloud-based network, a Local Area Network (LAN), a Wide Area Network (WAN), a Metropolitan Area Network (MAN), a Personal Area Network (PAN), an intranet, an extranet, and the Internet.

Some embodiments pertain to a method comprising: transmitting an indication that one or more advertisements are being played at the computing device; determining whether a user profile associated with a user of the apparatus has a sufficient amount of advertisement credits to allow the user to receive an advertisement-free experience relating to an advertisement-sponsored application; and providing the advertisement-free experience if the user profile includes the sufficient amount of advertisement credits.

Embodiments or examples include any of the above methods further comprising ceasing providing the advertisement-free experience if the user profile has run out of advertisement credits or does not include the sufficient amount of advertisement credits, wherein the sufficient amount includes an amount equal to or greater than a threshold amount of advertisement credits, wherein the threshold amount includes zero or greater than zero.

Embodiments or examples include any of the above methods wherein the indication further includes an identification of the one or more advertisements watched at the computing device, the computing device having a plurality of advertisement sponsor applications including the advertisement-sponsored application.

Embodiments or examples include any of the above methods wherein the indication is received at a server computing system maintaining the user profile, wherein the advertisement sponsored-application to check with the server computing system to determine whether the user profile has the sufficient amount of advertisements.

Embodiments or examples include any of the above methods wherein the indication comprises the advertisement credits to be added to the user profile for playing the one or more advertisements at the computing device, and wherein the computing device further having user preferences to determine, locally, how the advertisement credits are to be applied in relation to one or more of the plurality of advertisement sponsor applications.

Embodiments or examples include any of the above methods wherein the indication comprises the advertisement credits to be added to the user profile for playing the one or more advertisements at the computing device.

Embodiments or examples include any of the above methods wherein the computing device further having user preferences to determine, locally, how the advertisement credits are to be applied in relation to one or more of the plurality of advertisement sponsor applications.

Some embodiments pertain to a method comprising: tracking advertisement credits in a user profile relating to a user in response to receiving indications of a user receiving one or more advertisements at a computing device; and in response to a query from the computing device, providing a notification indicating a sufficient amount of advertisement credits relating to the advertisement sponsor application in the user profile.

Embodiments or examples include any of the above methods further comprising calculating and award the advertisement credits to the user based on a number of times the one or more advertisements are viewed by the user.

Embodiments or examples include any of the above methods further comprising calculating and award advertisement credits to the user in response to the user purchasing or leasing goods or services from one or more sponsored vendors.

Some embodiments pertain to a method comprising: detecting an advertisement request comprising user information received from a computing device; evaluating the request based on a user profile associated with a user associated with the user information, wherein the selection and control module is further to select an advertisement based on the evaluation of the request; calculating and assigning an amount of advertisement credit to the user profile; and transmission logic to transmit the selected advertisement to be displayed at the computing device.

Embodiments or examples include any of the above methods wherein the user profile includes one or more of user personal data, user preferences, and advertisement credits, wherein the user profile is stored at a database, wherein the user personal data comprises one or more of user name, user age, user gender, user location, user income, and user login, wherein the user personal data uniquely identifies the user or the computing device without identifying other user personally-identifiable user information.

Embodiments or examples include any of the above methods further comprising tracking and maintaining the user preferences relating to the user, wherein the user preferences include one or more of preferred websites, preferred vendors, preferred shopping items, and shopping habits, wherein the user preferences include advertising preferences.

Embodiments or examples include any of the above methods wherein the amount of advertisement credit is calculated to be corresponding to the selected advertisement and deposited to the user profile to be added to the advertisement credits, wherein the advertisement credits include redeemable monetary credits or non-monetary credits, wherein the advertisement credits are redeemable for one or more of purchasing, renting, leasing, and selling of one or more of services, consumer products or goods, software applications, outstanding balances, and other tangible and non-tangible items.

Embodiments or examples include any of the above methods further comprising registering the user, wherein registering the user includes creating the user profile and authenticating one or more of the user and the computing device.

Embodiments or examples include any of the above methods wherein evaluation of the request further comprises performing selection of the advertisement based on evaluation of user/advertisement data obtained from a third-party organization managing the user/advertisement data including one or more of advertisements, sponsor/vendor data, preference data, and credit data.

Some embodiments pertain to a method comprising: evaluating a received advertisement request comprising user information and to select one or more advertisements based on the advertisement request; and calculating an amount of advertisement credit associated with the one or more advertisements and assign the amount of advertisement credit to a user profile in response to receiving an indication that the user has watched the one or more advertisements.

Embodiments or examples include any of the above methods further comprising transmitting the selected one or more advertisements to be displayed at the computing device, wherein the transmission logic is further to pause transmission of additional advertisements to the user for a period of time after the user has watched the one or more advertisements to provide the user an advertisement-free experience for the period of time, wherein the period of time is based on the advertisement credit associated with the one or more advertisements.

Embodiments or examples include any of the above methods wherein the one or more advertisements are offered to the user based on user preferences relating to the user, wherein the user preferences include one or more of preferred websites, preferred vendors, preferred shopping items, and shopping habits, wherein the user preferences include advertising preferences, and wherein the amount of advertisement credit includes redeemable monetary credits or non-monetary credits, wherein the advertisement credit is redeemable for one or more of purchasing, renting, leasing, and selling of one or more of services, consumer products or goods, software applications, outstanding balances, and other tangible and non-tangible items.

Another embodiment or example incudes an apparatus to perform any of the methods mentioned above.

In another embodiment or example, an apparatus comprises means for performing any of the methods mentioned above.

In yet another embodiment or example, at least one machine-readable storage medium comprising a plurality of instructions that in response to being executed on a computing device, causes the computing device to carry out a method according to any of the methods mentioned above.

In yet another embodiment or example, at least one non-transitory or tangible machine-readable storage medium comprising a plurality of instructions that in response to being executed on a computing device, causes the computing device to carry out a method according to any of the methods mentioned above.

In yet another embodiment or example, a computing device arranged to perform a method according to any of the methods mentioned above.

Some embodiments pertain to a computing device comprising: advertisement sponsor logic to: transmit an indication that one or more advertisements are being played at the computing device; determine whether a user profile associated with a user of the apparatus has a sufficient amount of advertisement credits to allow the user to receive an advertisement-free experience relating to an advertisement-sponsored application; and provide the advertisement-free experience if the user profile includes the sufficient amount of advertisement credits.

Embodiments or examples include the above computing device wherein the advertisement sponsor logic is further to cease providing the advertisement-free experience if the user profile has run out of advertisement credits or does not include the sufficient amount of advertisement credits, wherein the sufficient amount includes an amount equal to or greater than a threshold amount of advertisement credits, wherein the threshold amount includes zero or greater than zero.

Embodiments or examples include the above computing device wherein the indication further includes an identification of the one or more advertisements watched at the computing device, the computing device having a plurality of advertisement sponsor applications including the advertisement-sponsored application.

Embodiments or examples include the above computing device wherein the indication is received at a server computing system maintaining the user profile, wherein the advertisement sponsored-application to check with the server computing system to determine whether the user profile has the sufficient amount of advertisements.

Embodiments or examples include the above computing device wherein the indication comprises the advertisement credits to be added to the user profile for playing the one or more advertisements at the computing device, and wherein the computing device further having user preferences to determine, locally, how the advertisement credits are to be applied in relation to one or more of the plurality of advertisement sponsor applications.

Embodiments or examples include the above computing device wherein the indication comprises the advertisement credits to be added to the user profile for playing the one or more advertisements at the computing device.

Embodiments or examples include the above computing device wherein the computing device further having user preferences to determine, locally, how the advertisement credits are to be applied in relation to one or more of the plurality of advertisement sponsor applications.

Some embodiments pertain to an apparatus comprising: preference/credit management logic to track advertisement credits in a user profile relating to a user in response to receiving indications of a user receiving one or more advertisements at a computing device; and advertisement communication logic to, in response to a query from the computing device, provide a notification indicating a sufficient amount of advertisement credits relating to the advertisement sponsor application in the user profile.

Embodiments or examples include the above apparatus wherein the preference/credit management logic is further to calculate and award the advertisement credits to the user based on a number of times the one or more advertisements are viewed by the user.

Embodiments or examples include the above apparatus wherein the preference/credit management logic is further to calculate and award advertisement credits to the user in response to the user purchasing or leasing goods or services from one or more sponsored vendors.

Some embodiments pertain to an apparatus comprising: detection module to detect an advertisement request comprising user information received from a computing device; selection and control module to evaluate the request based on a user profile associated with a user associated with the user information, wherein the selection and control module is further to select an advertisement based on the evaluation of the request; credit calculation logic to calculate and assign an amount of advertisement credit to the user profile; and transmission logic to transmit the selected advertisement to be displayed at the computing device.

Embodiments or examples include the above apparatus wherein the user profile includes one or more of user personal data, user preferences, and advertisement credits, wherein the user profile is stored at a database, wherein the user personal data comprises one or more of user name, user age, user gender, user location, user income, and user login, wherein the user personal data uniquely identifies the user or the computing device without identifying other user personally-identifiable user information.

Embodiments or examples include the above apparatus further comprising preference tracking logic to track and maintain the user preferences relating to the user, wherein the user preferences include one or more of preferred websites, preferred vendors, preferred shopping items, and shopping habits, wherein the user preferences include advertising preferences.

Embodiments or examples include the above apparatus wherein the amount of advertisement credit is calculated to be corresponding to the selected advertisement and deposited to the user profile to be added to the advertisement credits, wherein the advertisement credits include redeemable monetary credits or non-monetary credits, wherein the advertisement credits are redeemable for one or more of purchasing, renting, leasing, and selling of one or more of services, consumer products or goods, software applications, outstanding balances, and other tangible and non-tangible items.

Embodiments or examples include the above apparatus further comprising registration logic to register the user, wherein registering the user includes creating the user profile and authenticating one or more of the user and the computing device.

Embodiments or examples include the above apparatus wherein evaluation of the request further comprises performing selection of the advertisement based on evaluation of user/advertisement data obtained from a third-party organization managing the user/advertisement data including one or more of advertisements, sponsor/vendor data, preference data, and credit data.

Some embodiments pertain to an apparatus comprising: a selection and control module to evaluate a received advertisement request comprising user information and to select one or more advertisements based on the advertisement request; and credit calculation logic to calculate an amount of advertisement credit associated with the one or more advertisements and assign the amount of advertisement credit to a user profile in response to receiving an indication that the user has watched the one or more advertisements.

Embodiments or examples include the above apparatus further comprising transmission logic to transmit the selected one or more advertisements to be displayed at the computing device, wherein the transmission logic is further to pause transmission of additional advertisements to the user for a period of time after the user has watched the one or more advertisements to provide the user an advertisement-free experience for the period of time, wherein the period of time is based on the advertisement credit associated with the one or more advertisements.

Embodiments or examples include the above apparatus wherein the one or more advertisements are offered to the user based on user preferences relating to the user, wherein the user preferences include one or more of preferred websites, preferred vendors, preferred shopping items, and shopping habits, wherein the user preferences include advertising preferences, and wherein the amount of advertisement credit includes redeemable monetary credits or non-monetary credits, wherein the advertisement credit is redeemable for one or more of purchasing, renting, leasing, and selling of one or more of services, consumer products or goods, software applications, outstanding balances, and other tangible and non-tangible items.

Some embodiments pertain to an apparatus comprising: detection module to detect an advertisement request comprising user information received from a computing device; selection and control module to evaluate the request based on a user profile associated with a user associated with the user information, wherein the selection and control module is further to select an advertisement based on the evaluation of the request; credit calculation logic to calculate and assign an amount of advertisement credit to the user profile; and transmission logic to transmit the selected advertisement to be displayed at the computing device.

Embodiments or examples include any of the above apparatus wherein the user profile includes one or more of user personal data, user preferences, and advertisement credits, wherein the user profile is stored at a database.

Embodiments or examples include any of the above apparatus wherein the user personal data comprises one or more of user name, user age, user gender, user location, user income, and user login, wherein the user personal data uniquely identifies the user or the computing device without identifying other user personally-identifiable user information.

Embodiments or examples include any of the above apparatus further comprising preference tracking logic to track and maintain the user preferences relating to the user, wherein the user preferences include one or more of preferred websites, preferred vendors, preferred shopping items, and shopping habits, wherein the user preferences include advertising preferences.

Embodiments or examples include any of the above apparatus wherein the amount of advertisement is calculated to be corresponding to the selected advertisement and deposited to the user profile to be added to the advertisement credits, wherein the advertisement credits include redeemable monetary credits or non-monetary credits, wherein the advertisement credits are redeemable for one or more of purchasing, renting, leasing, and selling of one or more of services, consumer products or goods, software applications, outstanding balances, and other tangible and non-tangible items.

Embodiments or examples include any of the above apparatus further comprising registration logic to register the user, wherein registering the user includes creating the user profile and authenticating one or more of the user and the computing device.

Embodiments or examples include any of the above apparatus wherein evaluation the request further comprises performing selection of the advertisement based on evaluation of user/advertisement data obtained from a third-party organization managing the user/advertisement data including one or more of advertisements, sponsor/vendor data, preference data, and credit data.

Embodiments or examples include any of the above apparatus wherein the request is placed by the user via a user interface provided by a software application at the computing device, wherein the computing device comprises a client computing device including one or more of a desktop computer, a set-top box, a mobile computer including one or more of a smartphone, a personal digital assistant (PDA), a tablet computer, an e-reader, and a laptop computer, wherein the computing device is coupled to a server computing device over a network, the network including one or more of a cloud-based network, a Local Area Network (LAN), a Wide Area Network (WAN), a Metropolitan Area Network (MAN), a Personal Area Network (PAN), an intranet, an extranet, and the Internet.

Some embodiments pertain to an apparatus comprising: selection and control module to facilitate a user to select one or more advertisements by submitting an advertisement request via a computing device; comprising user information associated with the user; transmission logic to transmit the selected one or more advertisements to be displayed at the computing device; and credit calculation logic to calculate an amount of advertisement credit associated with the one or more advertisements and assigning the amount of advertisement credit to the user profile in response to the user watching the one or more advertisements.

Embodiments or examples include any of the above apparatus wherein the transmission logic is further to pause transmission of additional advertisements to the user for a period of time after the user has watched the one or more advertisements to facilitate the user an advertisement-free experience for the period of time.

Embodiments or examples include any of the above apparatus wherein the one or more advertisements are offered to the user based on user preferences relating to the user, wherein the user preferences include one or more of preferred websites, preferred vendors, preferred shopping items, and shopping habits, wherein the user preferences include advertising preferences.

Embodiments or examples include any of the above apparatus wherein the amount of advertisement credit includes redeemable monetary credits or non-monetary credits, wherein the advertisement credit is redeemable for one or more of purchasing, renting, leasing, and selling of one or more of services, consumer products or goods, software applications, outstanding balances, and other tangible and non-tangible items.

Embodiments or examples include any of the above apparatus wherein the request is placed by the user via a user interface provided by a software application at a computing device, wherein the computing device comprises a client computing device including one or more of a desktop computer, a set-top box, a mobile computer including one or more of a smartphone, a personal digital assistant (PDA), a tablet computer, an e-reader, and a laptop computer, wherein the computing device is coupled to a server computing device over a network, the network including one or more of a cloud-based network, a Local Area Network (LAN), a Wide Area Network (WAN), a Metropolitan Area Network (MAN), a Personal Area Network (PAN), an intranet, an extranet, and the Internet.

Some embodiments pertain to a system comprising: a computing device having a memory to store instructions, and a processing device to execute the instructions, the computing device further having a mechanism to: detect an advertisement request comprising user information received from a computing device; evaluate the request based on a user profile associated with a user associated with the user information, wherein evaluating includes selecting an advertisement based on the evaluation of the request; calculate and assign an amount of advertisement credit to the user profile; and transmit the selected advertisement to be displayed at the computing device.

Embodiments or examples include any of the above system wherein the user profile includes one or more of user personal data, user preferences, and advertisement credits, wherein the user profile is stored at a database, wherein the user personal data comprises one or more of user name, user age, user gender, user location, user income, and user login, wherein the user personal data uniquely identifies the user or the computing device without identifying other user personally-identifiable user information.

Embodiments or examples include any of the above system wherein the mechanism is further to track and maintain the user preferences relating to the user, wherein the user preferences include one or more of preferred websites, preferred vendors, preferred shopping items, and shopping habits, wherein the user preferences include advertising preferences.

Embodiments or examples include any of the above system wherein the amount of advertisement is calculated to be corresponding to the selected advertisement and deposited to the user profile to be added to the advertisement credits, wherein the advertisement credits include redeemable monetary credits or non-monetary credits, wherein the advertisement credits are redeemable for one or more of purchasing, renting, leasing, and selling of one or more of services, consumer products or goods, software applications, outstanding balances, and other tangible and non-tangible items.

Embodiments or examples include any of the above system wherein the mechanism is further to register the user, wherein registering includes creating the user profile and authenticating one or more of the user and the computing device, and wherein evaluating further comprises performing selection of the advertisement based on evaluation of user/advertisement data obtained from a third-party organization managing the user/advertisement data including one or more of advertisements, sponsor/vendor data, preference data, and credit data.

Embodiments or examples include any of the above apparatus wherein the request is placed by the user via a user interface provided by a software application at the computing device, wherein the computing device comprises a client computing device including one or more of a desktop computer, a set-top box, a mobile computer including one or more of a smartphone, a personal digital assistant (PDA), a tablet computer, an e-reader, and a laptop computer, wherein the computing device is coupled to a server computing device over a network, the network including one or more of a cloud-based network, a Local Area Network (LAN), a Wide Area Network (WAN), a Metropolitan Area Network (MAN), a Personal Area Network (PAN), an intranet, an extranet, and the Internet.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A computing device comprising:
advertisement sponsor logic to:
transmit an indication that one or more advertisements are being played at the computing device;
determine whether a user profile associated with a user of the apparatus has a sufficient amount of advertisement credits to allow the user to receive an advertisement-free experience relating to an advertisement-sponsored application; and
provide the advertisement-free experience if the user profile comprises the sufficient amount of advertisement credits.

2. The computing device of claim 1, wherein the advertisement sponsor logic is further to cease providing the advertisement-free experience if the user profile has run out of advertisement credits or does not comprise the sufficient amount of advertisement credits, wherein the sufficient amount comprises an amount equal to or greater than a threshold amount of advertisement credits, wherein the threshold amount comprises zero or greater than zero.

3. The computing device of claim 1, wherein the indication further comprises an identification of the one or more advertisements watched at the computing device, the computing device having a plurality of advertisement sponsor applications including the advertisement-sponsored application.

4. The computing device of claim 1 or 3, wherein the indication is received at a server computing system maintaining the user profile, wherein the advertisement sponsored-application to check with the server computing system to determine whether the user profile has the sufficient amount of advertisements.

5. The computing device of claim 1, wherein the indication comprises the advertisement credits to be added to the user profile for playing the one or more advertisements at the computing device, and wherein the computing device further having user preferences to determine, locally, how the advertisement credits are to be applied in relation to one or more of the plurality of advertisement sponsor applications.

6. An apparatus comprising:
preference/credit management logic to track advertisement credits in a user profile relating to a user in response to receiving indications of a user receiving one or more advertisements at a computing device; and
advertisement communication logic to, in response to a query from the computing device, provide a notification indicating a sufficient amount of advertisement credits relating to the advertisement sponsor application in the user profile.

7. The apparatus of claim 6, wherein the preference/credit management logic is further to calculate and award the advertisement credits to the user based on a number of times the one or more advertisements are viewed by the user.

8. The apparatus of claim 7, wherein the preference/credit management logic is further to calculate and award the advertisement credits to the user in response to the user purchasing or leasing goods or services from one or more sponsored vendors.

9. The apparatus of claim 6, further comprising:
detection module to detect an advertisement request comprising user information received from the computing device;
selection and control module to evaluate the request based on the user profile associated with the user associated with the user information, wherein the selection and control module is further to select one or more advertisements based on the evaluation of the request;
credit calculation logic to calculate and assign an amount of advertisement credit of the advertisement credits to the user profile; and
transmission logic to transmit the selected one or more advertisements to be displayed at the computing device.

10. The apparatus of claim 9, wherein the user profile comprises one or more of user personal data, user preferences, and the advertisement credits, wherein the user profile is stored at a database, wherein the user personal data comprises one or more of user name, user age, user gender, user location, user income, and user login, wherein the user personal data uniquely identifies the user or the computing device without identifying other user personally-identifiable user information.

11. The apparatus of claim 10, further comprising preference tracking logic to track and maintain the user preferences relating to the user, wherein the user preferences comprise one or more of preferred websites, preferred vendors, preferred shopping items, and shopping habits, wherein the user preferences comprise advertising preferences.

12. The apparatus of claim 10, wherein the amount of advertisement credit is calculated to be corresponding to the selected one or more advertisements and deposited to the user profile to be added to the advertisement credits, wherein the advertisement credits comprise redeemable monetary credits or non-monetary credits, wherein the advertisement credits are redeemable for one or more of purchasing, renting, leasing, and selling of one or more of services, consumer products or goods, software applications, outstanding balances, and other tangible and non-tangible items.

13. The apparatus of claim 9, further comprising registration logic to register the user, wherein registering the user comprises creating the user profile and authenticating one or more of the user and the computing device.

14. The apparatus of claim 9, wherein evaluation of the request further comprises performing selection of the one or more advertisements based on evaluation of user/advertisement data obtained from a third-party organization managing the user/advertisement data including one or more of advertisements, sponsor/vendor data, preference data, and credit data.

15. The apparatus of claim 9, wherein the credit calculation logic is further to calculate the amount of advertisement credit associated with the one or more advertisements and assign the amount of advertisement credit to the user profile in response to receiving an indication that the user has watched the one or more advertisements.

16. The apparatus of claim 15, further comprisingwherein the transmission logic is further to transmit the selected one or more advertisements to be displayed at the computing device, wherein the transmission logic is further to pause transmission of additional advertisements to the user for a period of time after the user has watched the one or more advertisements to provide the user an advertisement-free experience for the period of time, wherein the period of time is based on the advertisement credit associated with the one or more advertisements.

17. The apparatus of claim 16, wherein the one or more advertisements are offered to the user based on user preferences relating to the user, wherein the user preferences comprise one or more of preferred websites, preferred vendors, preferred shopping items, and shopping habits, wherein the user preferences comprise advertising preferences, and wherein the amount of advertisement credit comprises redeemable monetary credits or non-monetary credits, wherein the advertisement credit is redeemable for one or more of purchasing, renting, leasing, and selling of one or more of services, consumer products or goods, software applications, outstanding balances, and other tangible and non-tangible items.

18-25. (canceled)

26. A method comprising:
transmitting an indication that one or more advertisements are being played at the computing device;
determining whether a user profile associated with a user of the apparatus has a sufficient amount of advertisement credits to allow the user to receive an advertisement-free experience relating to an advertisement-sponsored application; and
providing the advertisement-free experience if the user profile comprises the sufficient amount of advertisement credits.

27. The method of claim 26, further comprising ceasing to provide the advertisement-free experience if the user profile has run out of advertisement credits or does not comprise the sufficient amount of advertisement credits, wherein the sufficient amount comprises an amount equal to or greater than a threshold amount of advertisement credits, wherein the threshold amount comprises zero or greater than zero.

28. The method claim 26, wherein the indication further comprises an identification of the one or more advertisements watched at the computing device, the computing device having a plurality of advertisement sponsor applications including the advertisement-sponsored application.

29. A method comprising:
tracking advertisement credits in a user profile relating to a user in response to receiving indications of a user receiving one or more advertisements at a computing device; and
providing, in response to a query from the computing device, a notification indicating a sufficient amount of advertisement credits relating to the advertisement sponsor application in the user profile.

30. The method of claim 29, further comprising calculating and awarding the advertisement credits to the user based on a number of times the one or more advertisements are viewed by the user.

31. The method of claim 30, further comprising calculating and awarding the advertisement credits to the user in response to the user purchasing or leasing goods or services from one or more sponsored vendors.

32. At least one machine-readable medium comprising a plurality of instructions that in response to being executed on a computing device, causes the computing device to carry out one or more operations comprising:
tracking advertisement credits in a user profile relating to a user in response to receiving indications of a user receiving one or more advertisements at a computing device; and
providing, in response to a query from the computing device, a notification indicating a sufficient amount of advertisement credits relating to the advertisement sponsor application in the user profile.

33. The machine-readable medium of claim 32, wherein the one or more operations further comprise calculating and awarding the advertisement credits to the user based on a number of times the one or more advertisements are viewed by the user.

34. The machine-readable medium of claim 33, wherein the one or more operations further comprise calculating and awarding the advertisement credits to the user in response to the user purchasing or leasing goods or services from one or more sponsored vendors.
